(19) United States
(12) Patent Application Publication
(10) Pub. No.: US 2026/0239317 A1
(43) Pub. Date: Aug. 13, 2026

(54) Serving Carrier Prediction for Mobility Management

(71) Applicant: Telefonaktiebolaget LM Ericsson (publ), Stockholm (SE)

(72) Inventors: Jose Maria RUIZ AVILES, MÁLAGA (ES); Paulo Antonio MOREIRA MIJARES, MÁLAGA (ES); Juan RAMIRO MORENO, MÁLAGA (ES); Jose OUTES CARNERO, Torremolinos (ES); Adriano MENDO MATEO, MÁLAGA (ES); Yak NG MOLINA, MÁLAGA (ES); Rakibul Islam RONY, MÁLAGA (ES)

(21) Appl. No.: 19/149,618

(22) PCT Filed: Apr. 5, 2023
(86) PCT No.: PCT/IB2023/053493

§ 371 Date: Jul. 21, 2025

(30) Foreign Application Priority Data
Feb. 3, 2023 (EP) 23382097.6

(51) Int. Cl. H04W 72/0453; H04B 17/318; H04W 72/51

(52) U.S. Cl. CPC H04W 72/0453; H04B 17/328; H04W 72/51

(57) ABSTRACT

According to some embodiments, a method is performed by a network node for predicting serving carriers in a wireless network for a target geographical area. The method comprises determining a first set of features from a first set of inputs for each geographical area of a first plurality of geographical areas where samples of data are available. The method further comprises determining a second set of features from a second set of inputs for each geographical area of a second plurality of geographical areas where samples of data are not available; determining that the first set of features associated with a first geographical area corresponds to the second set of features associated with a second geographical area areas; and determining that a serving carrier for the first geographical area is the serving carrier for the second geographical area.

### TECHNICAL FIELD

Embodiments of the present disclosure are directed to wireless communications and, more particularly, to an artificial intelligence (AI)-powered serving carrier predictor to characterize and emulate an inter-frequency mobility management system.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) defines standards for policy and charging control framework. Network design and optimization is a key activity for operators to guarantee that new or existing services fulfill user demands. As part of these processes, in a classical way of working, radio engineers carry out a thorough spatial analysis of the radio frequency (RF) environment to predict the service quality in each location of the area under study. In this context, it is crucial to know accurately which areas are served by each carrier.

There are different solutions to calculate the most important RF metrics for a given cell in a certain area, and it is not significantly complex to know which cell in a given unique carrier would be the serving cell in a certain location by means of the intra-frequency mobility configuration analysis. However, when there are several carriers, interpreting the inter-frequency mobility management system configuration can be a challenging task due to a large number of parameters, objects and system features that are involved in the process, especially in a multi-vendor environment, and even worse if detailed documentation is not available.

Normally, this is performed using a manual and time-consuming analysis of all the configuration parameters and network features. In normal operation, engineers decide what the optimal traffic sharing between carriers is, trying to obtain the maximum performance from the existing resources, and then they adjust the configuration parameters in the network trying to fulfill the designed requirements in terms of traffic sharing and coverage.

This process is increasing in complexity with the evolution of the radio access network (RAN) and the addition of more and more carriers and technologies. As a result, it is not always possible to fulfill the design requirements easily. Additionally, to understand how a certain configuration is distributing the traffic between carriers in every area is a difficult challenge. Currently, no methodology exists to improve this process.

There currently exist certain challenges. As presented above, there are no solutions to address the described problem, which is normally solved using methodologies based on simplistic rules (e.g., best coverage carrier, hardcoded priorities, etc.) and, more commonly used, manual analysis of inter-frequency mobility. The main problems with the current methodology include the following:
Time-consuming: the manual analysis of the network configuration takes a long time and significant effort due to a large number of network configuration parameters, features and objects involved in the process.
Lower granularity: the level of detail of the manual analysis is limited by human capacity, so it will have a lower granularity, which complicates design and optimization activities.
High expertise: the correct analysis of the inter-frequency mobility strategy requires a very high level of radio engineering expertise, which is not always available.
Multi-vendor aspects: even if an expert engineer is available, dealing with a new vendor would require access to detailed documentation that is not always available.
Human errors: because this methodology is manual, human errors can cause an incorrect interpretation of the inter-frequency mobility strategy that may lead to erroneous conclusions.
Not scalable: because this methodology is based on human interpretation, it is not scalable and its application to large areas is not feasible.

### SUMMARY

As described above, certain challenges currently exist with the detection of serving carriers. Certain aspects of the disclosure and their embodiments may provide solutions to these or other challenges. For example, particular embodiments are provided to overcome the problems described above by learning automatically from real user samples in the area how the network configuration and the system features are spatially splitting the traffic among the existing carriers.

Particular embodiments include predicting the serving carrier in a mobile network, i.e., in which carrier a user equipment (UE) will establish its connection for a given location, based on existing samples from real UEs and artificial intelligence (AI). Particular embodiments may be applied in a per-pixel basis, i.e., the target area is divided in small square areas of a certain resolution (e.g., 20 m×20 m) and the serving carrier is predicted in each of these areas or pixels.

Interpreting the inter-frequency mobility configuration in a mobile network to determine the serving carrier in each location is a deterministic problem, but its resolution is complex due to the large number of parameters and objects involved in the process and the relation between them (e.g., the configuration of a cell in carrier A may move a user to a cell in carrier B, and at the same time, the configuration of the cell in carrier B may move the same user to a cell in carrier C).

Certain embodiments may provide one or more of the following technical advantages. For example, particular embodiments described herein automatically learn the network configuration from real users using an AI model and then use the obtained model to predict the server carrier in other locations. Particular embodiments use available real user data (e.g., crowdsourced data) to learn by means of AI how the configuration of the inter-frequency management system leads the user to a specific carrier.

Although particular embodiments have been validated using crowdsourced data as an input data source, there are other alternatives that may also be used (e.g., UE traces, drive-tests, etcetera). In some embodiments, any data source that contains user records detailing the signal strength that the user is receiving from the different cells in each carrier and an identification of the serving cell for that specific user is a sufficient data source.

In some embodiments, the information is complemented with information from the network, such as performance monitoring (PM) and configuration management (CM) data, which is analyzed to gain insights on the status of the network at the time of the user record (e.g., cell loads, cell configurations, etcetera). The present disclosure describes counters and parameters used for a Long Term Evolution (LTE) network, but it can be adapted to other technologies.

The data sources are used to calculate a set of features that represent the status of the network and the user at the time of each record. Likewise, these features, together with the known serving cell (i.e., the label) may be used to train an AI-supervised learning model. Finally, the trained model predicts the serving carrier in any location and under different network conditions, which is a powerful and accurate tool for network design.

The implementation of some embodiments presented here is focused on fourth generation (4G) technology, however, the same concept may also be applied to other technologies (e.g., fifth generation (5G)).

The corresponding description below describes certain contributions of some embodiments. The usage of AI to solve the problem described above has been demonstrated to be reliable and helpful, e.g., as described with respect to FIG. 3. With the evolution of technology and the addition of more and more carriers, networks have become more complex. The analysis of the inter-frequency mobility has turned into a hard and time-consuming task. Likewise, even if the configuration analysis is carried out successfully, to determine the serving carrier in each location of a big area is also a challenging process (only feasible for a very low granularity or using simplistic rules). Particular embodiments improve the analysis.

The potential to use crowdsourced data as input makes particular embodiments agile and easily applicable. Crowdsourced data may be easily obtained without the intervention of operators, which eliminates dependency on other heavier and demanding data sources (e.g., call traffic recording (CTR) traces in LTE), which may also include privacy concerns.

Particular embodiments include determining a number of features that synthesize the status of the network and the RF environment of the UE accurately, which determine the serving carrier.

Training the AI model in the same area where the predictions are carried out makes a solution thoroughly adjusted to the environment. It is, therefore, an automatic process that, however, is using a model completely customized for the given network.

According to some embodiments, a method is performed by a network node for predicting serving carriers in a wireless network for a target geographical area. In a learning/training phase, the method comprises obtaining a first set of inputs that comprise samples of data indicating a status of a network (e.g., RSRP/RSRQ as measured by UE) in a first plurality of geographical areas. For each geographical area of the first plurality of geographical areas where the samples of data are available, the method comprises: determining a first set of features from the first set of inputs. The first set of features indicate performance indicators of a cell in a respective geographical area of the first plurality of geographical areas. The method further comprises determining a serving carrier from the first set of inputs and the first set of features. In a prediction phase, the method further comprises obtaining a second set of inputs indicating a status of a network in a second plurality of geographical areas. For each geographical area of the second plurality of geographical areas where samples of data are not available, the method further comprises: determining a second set of features from the second set of inputs, wherein the second set of features indicates performance indicators of a cell in a respective geographical area of the second plurality of geographical areas; determining that more than a threshold number of the first set of features associated with a first geographical area from among the first plurality of geographical areas corresponds to counterpart features from among the second set of features associated with a second geographical area from among the second plurality of geographical areas; and in response to determining that more than the threshold number of the first set of features associated with the first geographical area corresponds to the counterpart features from among the second set of features associated with the second geographical area, determining that the serving carrier associated with the first geographical area is the serving carrier for the second geographical area.

In particular embodiments, each set of features of the first set of features is labeled with a respective serving carrier. The first set of features labeled with respective serving carriers is used to train a machine learning algorithm that is configured to predict serving carriers in geographical areas other than the first plurality of geographical areas based at least on the first set of features labeled with respective serving carriers.

In particular embodiments, the first set of inputs comprises one or more of the following: serving cell RSRP measurement for a respective cell in the respective geographical area of the first plurality of geographical areas; serving cell RSRQ measurement for the respective cell in the respective geographical area of the first plurality of geographical areas; PM data for the respective cell in the respective geographical area of the first plurality of geographical areas; and CM data for the respective cell in the respective geographical area of the first plurality of geographical areas.

In particular embodiments, the first set of features comprises at least one of the following: load of a respective cell during a period when the first set of inputs is obtained; reference signal received power (RSRP) in a respective geographical area from the respective cell; reference signal received quality (RSRQ) in the respective geographical area from the respective cell; ranking that indicates a ranking of the respective cell compared to other cells in terms of RSRP values; a1a2SearchThresholdRsrp that represents a RSRP threshold value for the respective cell that determines whether a user equipment (UE) enters or leaves an inter-frequency search zone; a1a2Search ThresholdRsrq that represents an RSRQ threshold value for the respective cell that determines whether a UE enters or leaves the inter-frequency search zone; a2CriticalThresholdRsrp that represents an RSRP threshold value for the respective cell that determines whether a UE starts or stops searching for target cells in other frequencies to leave a serving cell; a2CriticalThresholdRsrq that represents a RSRQ threshold value for the respective cell that determines whether a UE starts or stops searching for target cells in other frequencies to leave the serving cell; inhibitA2SearchConfig that indicates whether RSRP and RSRQ measurements take effect in a mobility control at a less than a threshold percentage coverage; and best RSRP carrier that indicates a carrier with a highest RSRP in the respective geographical area.

In particular embodiments, one or more of the RSRP and RSRQ are obtained via a prediction tool.

In particular embodiments, the second set of inputs comprises one or more of the following: serving cell RSRP measurement for a respective cell in the respective geographical area of the second plurality of geographical areas; serving cell RSRQ measurement for the respective cell in the respective geographical area of the second plurality of geographical areas; PM data for the respective cell in the respective geographical area of the second plurality of geographical areas; and CM data for the respective cell in the respective geographical area of the second plurality of geographical areas.

In particular embodiments, the second set of features comprises one or more of the following: load that indicates an average percentage of PRBs used for a respective cell during a period when the serving carrier for the respective cell is going to be predicted; RSRP that indicates RSRP in a respective geographical area from the respective cell; RSRQ that indicates RSRQ in the respective geographical area from the respective cell; ranking that indicates a ranking of the respective geographical cell compared to other cells in terms of RSRP values; a1a2SearchThresholdRsrp that represents a RSRP threshold value for the respective cell that determines whether a user equipment (UE) enters or leaves an inter-frequency search zone; a1a2SearchThresholdRsrq that represents a RSRQ threshold value for the respective cell that determines whether a UE enters or leaves the inter-frequency search zone; a2CriticalThresholdRsrp that represents an RSRP threshold value for the respective cell that determines whether a UE starts or stops searching for target cells in other frequencies to leave a serving cell; a2CriticalThresholdRsrq that represents an RSRQ threshold value for the respective cell that determines whether a UE starts or stops searching for target cells in other frequencies to leave the serving cell; inhibitA2SearchConfig that indicates whether RSRP and/or RSRQ measurements take effect in a mobility control at a less than a threshold percentage coverage; and best RSRP carrier that indicates a carrier with a highest RSRP in the respective geographical area.

In particular embodiments, the first set of inputs comprises crowdsourced records.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, some embodiments include a high level of accuracy. Server carrier predictions have been highly accurate, with more than 60% of successful predictions in a scenario with nine possible server carriers. Compared with other commonly used methodologies (e.g., selection of the carrier with higher reference signal received power (RSRP)), the accuracy is 40 percentage points higher. Even with a thorough and time-consuming analysis of the network configuration, it is complicated to obtain such a high accuracy, because even in that case some of the inputs needed (e.g., the RSRP and reference signal received quality (RSRQ) in the different carriers) would be obtained by means of predictions. Additionally, because the AI model is trained in the same area where the predictions are calculated, the model is adjusted to the target area, therefore increasing accuracy.

Another advantage is that particular embodiments are quick/effortless after the required inputs are compiled. Execution of a prediction is almost instantaneous, e.g., taking just a few seconds to calculate the features, train the AI model and predict the server carrier for a network of more than 1000 cells. Compared with a thorough analysis of the network configuration, the time is almost negligible. Additionally, CS data, which is the main input, is easily accessible, which makes the process effortless.

Particular embodiments may be applied to a large area to determine automatically and precisely how the inter-frequency configuration is splitting in every pixel the traffic among the different carriers.

Particular embodiments are technology and vendor agnostic. Because the main inputs may be crowdsourced data and general PM counters and CM parameters available for any technology and vendor, particular embodiments may be applied to any mobile network, regardless of the vendor or the technology.

Particular embodiments may be applied in a different network. Due to the nature of the particular embodiments, a model may be trained in an area, and the model may be used to predict in a different area or even in a non-existing network.

Particular embodiments may be applied with different configuration parameters. After the model is trained, the model may be used with different values of the configuration parameter to test the impact of those parameter changes.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a flow diagram illustrating a feature calculation process for training an artificial intelligence (AI) model, according to certain embodiments;

FIG. 2 is a flowchart illustrating the training and prediction processes, describing how the inputs are used in the training and the prediction phase to obtain the server carrier prediction for all the given pixels in a new network, according to certain embodiments;

FIG. 3 is a graph illustrating the predicted server carrier in each pixel of the area using two different approaches;

FIG. 4 is a block diagram illustrating an example wireless network, according to particular embodiments;

FIG. 5 illustrates an example user equipment, according to certain embodiments;

FIG. 6 is a schematic block diagram illustrating a virtualization environment, according to certain embodiments;

FIG. 7 illustrates an example telecommunication network connected via an intermediate network to a host computer, according to certain embodiments;

FIG. 8 illustrates an example host computer communicating via a base station with a user equipment over a partially wireless connection, according to certain embodiments;

FIG. 9 is a flowchart illustrating a method implemented in a communication system, according to certain embodiments;

FIG. 10 is a flowchart illustrating a method implemented in a communication system, according to certain embodiments;

FIG. 11 is a flowchart illustrating a method implemented in a communication system, according to certain embodiments; and

FIG. 12 is a flowchart illustrating a method implemented in a communication system, according to certain embodiments; and

FIG. 13 is a flowchart illustrating an example method in a network node, according to certain embodiments.

### DETAILED DESCRIPTION

Some of the embodiments will now be described more fully with reference to the accompanying drawings. Embodiments are provided by way of example to convey the scope of the subject matter to those skilled in the art.

The following subsections provide a detailed description of particular embodiments. The first section describes the inputs used and how they are obtained. The second section explains how the inputs are used to calculate a set of Key Performance Indicators (KPIs) or features that are used as input to an AI model. The third section describes how the AI model is first trained and then used to predict. The fourth section includes the flowchart of an example embodiment, and the fifth section presents a proof of concept carried out with an example embodiment in a real network.

Input data source

In some embodiments, three different inputs are used. These inputs may collectively be referred to as inputs regarding the status of a network. The status includes user equipment status and measurements. The three inputs are described below:

1. Serving Cell. RSRP and RSRQ Measurements:

This input comprises records, each of them corresponding to a user measurement. The records contain the RSRP and/or the RSRQ for the best server cell of each carrier and, in the training phase, the records also contain the actual serving carrier for the given record.

In some embodiments, the RSRP and RSRQ values may be the real measurements provided by the UEs. In some embodiments, the RSRP and RSRQ values may be calculated or predicted by other tools. For example, in some embodiments, a tool based on patent applications WO2021191011A1, WO2022042891A1 and WO2022090810A1 has been used to predict RSRP and RSRQ values after the locations of the records are known.

When the serving carrier is being predicted, normally RSRP and RSRQ values are obtained from prediction tools, because real measurement records are not available for these locations (note that if they were available, then serving carrier would be known, and predictions would not be needed). Again, in some embodiments, a tool has been used to predict the RSRP and RSRQ in the locations where the serving cell is going to be predicted.

In some embodiments, the actual serving cell of the record may be obtained from real user measurements. If there are several records in the same pixel and time period with different serving carriers, then one record of the most repeated serving carrier may be selected. In some embodiments, the actual serving cell may be obtained from crowdsourced data in the training stage, which is easily accessible.

In some embodiments, there are other data sources that may be used to obtain the required information in addition to or instead of the data sources described above. For example, UE traces contain RSRP and RSRQ for all the carriers and an indication of the serving carrier, but they are not as easily accessible as crowdsourced. In another example, drive-tests are an alternative that contain sufficient information, and they can be adapted to the requirements and particularities of each project, although they are costly and not always feasible.

### 2. Performance Management (PM) Data:

In some embodiments, some or all PM counters used to calculate KPIs that are potentially related to inter-frequency mobility strategy may be collected. In some embodiments, certain PM counters to calculate the load of all the cells reported in the records described in the previous input at the time the measurements were taken may be collected (e.g., in LTE network).

### 3. Configuration Management (CM) Data:

In some embodiments, some or all network parameters and system feature parameters related to inter-frequency mobility may be collected at the time reported in the records described in the first input. Some embodiments may include non-standard or proprietary parameters. For example, some LTE embodiments may collect the following parameters: a1a2SearchThresholdRsrp, a1a2SearchThresholdRsrq, a2CriticalThresholdRsrp, a2CriticalThresholdRsrq, and/or inhibitA2SearchConfig.

### Features

In some embodiments, a set of features (i.e., AI model input KPIs) is calculated using the inputs described above for each pixel where the server carrier is known (i.e., real user measurement records used for training) or where the carrier is going to be predicted (i.e., all features are calculated to predict the serving carrier). For example, a pixel may be defined as a square area (e.g., 20 m×20 m), and all records inside that area belong to the same pixel. The pixel size is configurable and may be adapted to the size of the area and the type of terrain.

First, for each carrier in the network, the best server cell in the carrier for the given pixel is identified as the cell with the highest RSRP in that location, and then for each of these cells the following KPIs are calculated:

Cell_{Carrier_i} load: calculated as the average percentage of physical resource blocks (PRBs) used for the given cell during the period that contains the real user measurement record (in training) and/or for the period in which the server carrier will be predicted (in prediction). For example, it may be calculated using a particular counter for LTE, which is available in the PM data.

Cell_{Carrier_i} RSRP: the RSRP in the given location from the given cell. In some embodiments, if the RSRP is obtained from real users records and there is more than one record for the given pixel, then the value of the feature is the median RSRP of those records.

Cell_{Carrier_i} RSRQ: the RSRQ in the given location from the given cell. In some embodiments, if the RSRQ is obtained from real users records and there is more than one record for the given pixel, then the value of the feature is the median RSRQ of those records.

Cell_{Carrier_i} ranking: the ranking in terms of RSRP in which the cell is compared with the other best server cells from the other carriers. For example, if the RSRP of the given cell in the given location is the highest, then the value of this feature is 1.

CellCarrier i a1a2SearchThresholdRsrp: the RSRP threshold value for the given cell that determines if the UE enters/leaves the inter-frequency search zone (i.e., UE starts/stops reporting measurements). This parameter is part of the Mobility Control at Poor Coverage network feature, and it is available in the CM data. The poor coverage may be referred to as less than a threshold network coverage, such as less than a threshold RSPR and/or a threshold RSRQ.

Cell_{Carrier_i} a1a2SearchThresholdRsrq: the RSRQ threshold value for the given cell that determines if the UE enters/leaves the inter-frequency search zone (i.e., UE starts/stops reporting measurements). This parameter is part of the Mobility Control at Poor Coverage network feature, and it is available in the CM data.

Cell_{Carrier_i} a2CriticalThresholdRsrp: the RSRP threshold value for the given cell that determines if the UE enters/leaves critical zone (i.e., UE starts/stops searching target cells in other frequencies to leave the server cell). This parameter is part of the Mobility Control at Poor Coverage network feature, and it is available in the CM data.

Cell_{Carrier_i} a2CriticalThresholdRsrq: the RSRQ threshold value for the given cell that determines if the UE enters/leaves critical zone (i.e., UE starts/stops searching target cells in other frequencies to leave the server cell). This parameter is part of the Mobility Control at Poor Coverage network feature, and it is available in the CM data.

Cell_{Carrier_i} inhibitA2SearchConfig: it determines if RSRP, RSRQ or both types of measurements take effect in the Mobility Control at Poor Coverage. This parameter is part of the Mobility Control at Poor Coverage network feature, and it is available in the CM data.

Best RSRP carrier: The carrier with the highest RSRP in the given pixel, identified by a number between 1 and N, where N is the number of carriers. 1 identifies the carrier with lowest frequency, and N identifies the carrier with highest frequency.

Additionally, the serving carrier obtained from the real user measurements is used as a label in the training process. Carriers are again identified by a number between 1 and N, where 1 is the carrier with lowest frequency and N is the carrier with highest frequency.

The KPIs described above may be included in some embodiments, however other approaches may be used, including a subset of these KPIs or adding more features. For example, in some embodiments, more parameters related with inter-frequency mobility, new KPIS calculated using PM data, or other RF metrics in the given location calculated with other tools or available in the real user measurement data (e.g., channel quality indicator (CQI), signal to interference noise ratio (SINR), etc.). In some embodiments described herein, features are focused on 4G, but equivalent features for other technologies (e.g., 3G or 5G) may be included in other embodiments.

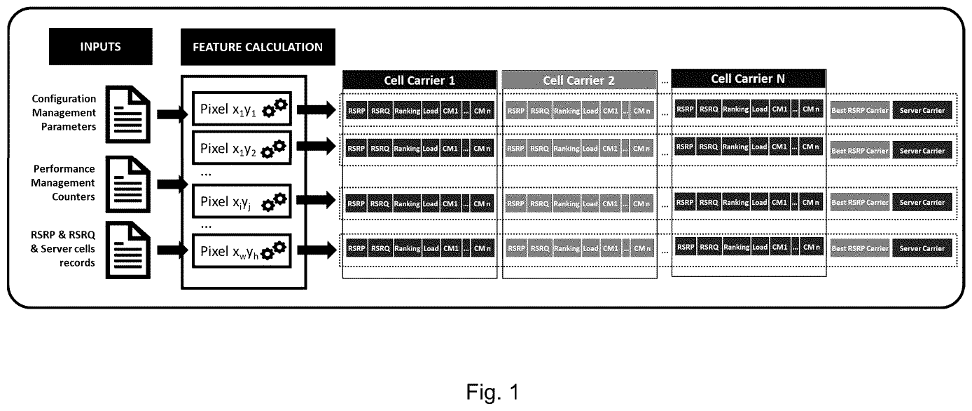

FIG. 1 is a flow diagram illustrating a feature calculation process for training an artificial intelligence (AI) model. As shown in FIG. 1, the set of inputs are obtained and used to calculate the set of features for each pixel xᵢyᵢ from among a set of pixels, where the xᵢyᵢ represents a location of each pixel, and i a natural number. A respective serving carrier for each pixel is determined based on a respective set of features and inputs.

### Training

In some embodiments, in the training phase, input data containing real user measurement records, which specify the serving carrier, is used to train a supervised machine learning model. These are the records where the serving carrier is known and used to find the values of the parameters in a supervised machine learning model that achieves a minimum prediction error in those records.

In some embodiments, all the features except the Cell_{Carrier_i} RSRP and Cell_{Carrier_i} RSRQ are calculated using real data. Cellcarrier i RSRP and Cell_{Carrier_i} RSRQ, are calculated using the previously mentioned prediction tool. Some embodiments adapt the training to the same conditions that will be later used in the prediction phase for the sake of consistency.

Some embodiments may use the RSRP and RSRQ available in real user measurement records to calculate these features in the training phase.

In some embodiments, the AI model may be a Random Forest classification model. This model has been selected due to its versatility, simplicity, and its good performance, especially with the type of operations performed by particular embodiments.

An AI model that is easy to train and use is advantageous in this process, because the purpose is to train the model for each new network automatically without the intervention of an AI expert.

### Prediction

One purpose of particular embodiments is to predict the serving carrier in the locations where there are not real user measurement records available. In those pixels, Cell_{Carrier_i} RSRP and Cell_{Carrier_i} RSRQ may be obtained using other predictions tools. The rest of the features may be calculated, as in the training phase, using PM and CM data. In some embodiments, KPIs related to PM and CM data may not be real, but may comprise proposed values to test the impact of those KPIs for the serving carrier prediction in each pixel.

After all the features are calculated, they are used as input of the model previously trained as explained herein, and then the serving carrier prediction is obtained for each of the given pixels.

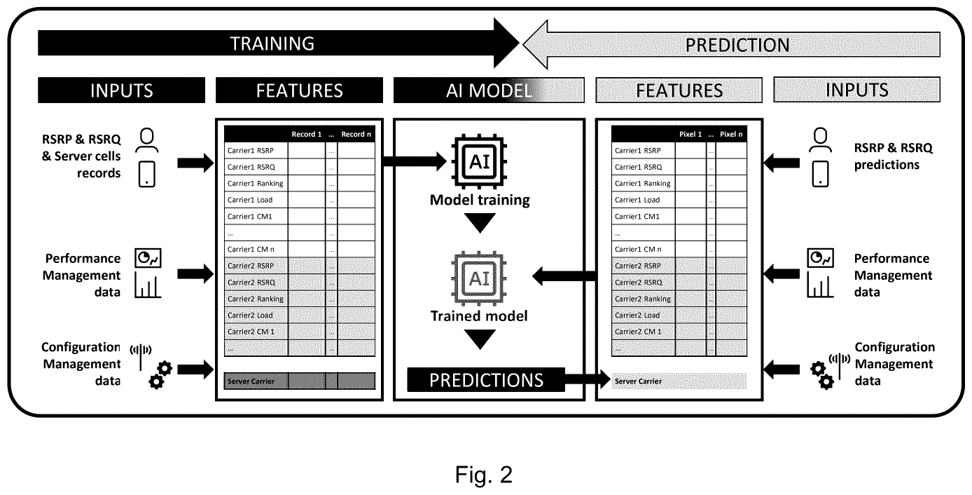

FIG. 2 is a flowchart illustrating the training and prediction processes, describing how the inputs are used in the training and the prediction phase to obtain the server carrier prediction for all the given pixels in a new network, according to certain embodiments. As can be seen in FIG. 2, in the training process, the inputs are obtained and used to determine the features per pixel, per cell, and per carrier.

Each set of features is labeled with a respective serving carrier. This information is used as a training dataset by the AI model to learn the associations between each set of features and its respective serving carrier (i.e., label). In other words, the AI model is given a plurality of sets of features, each labeled with a respective serving carrier and is asked to learn their associations and relationships with each other.

In the prediction stage (or testing stage), the AI model is given unlabeled set of features and is asked to predict its serving carrier. The unlabeled set of features may be obtained from a set of (testing) inputs and may be for pixels where real user measurements are not available. The AI model may compare the training dataset with the unlabeled set of features to determine which of the labeled set of features (from the training dataset) corresponds to the unlabeled set of features. For example, if the AI model determines that a first set of features (that is labeled with a particular serving carrier) from the training dataset corresponds to a second set of features that is unlabeled, the AI model may determine that the particular serving carrier is the serving carrier for a particular pixel associated with the second set of features. In some embodiments, the AI model may determine that the first set of features corresponds to the second set of features if more than a threshold number of the first set of features (e.g., more than 90%, 95%, etc.) correspond to counterpart features from among the second set of features.

In some embodiments, the AI model may determine a Euclidean distance between a first feature vector that represents the first set of features and a second feature vector that represents the second set of features. If the Euclidean distance is less than a threshold percentage, the AI model may determine that the first set of features corresponds to the second set of features.

In some embodiments, the AI model may use cosine similarity between the first set of features and the second set of features to determine if they correspond to or match each other.

An example embodiment of the proposed system has been tested in a mature live network with 7 carriers in LTE. The carriers in LTE are 800 MHZ, 1800 MHZ, 2100 MHz, 2600 MHz and 3 more carriers in 2300 MHz (with E-UTRA absolute radio frequency channel number, EARFCN, 39148, 38950 and 38752 respectively). These 7 carriers have a total of 113 sites and 874 cells in the area under study.

The example network is an example of the complexity of understanding in which carrier a new user will establish its connection depending on its location. With 7 cells involved in the decision, the number of parameters to be analy zed is large (i.e., cell parameters, frequency-relation parameters, cell-relation parameters, features, etcetera).

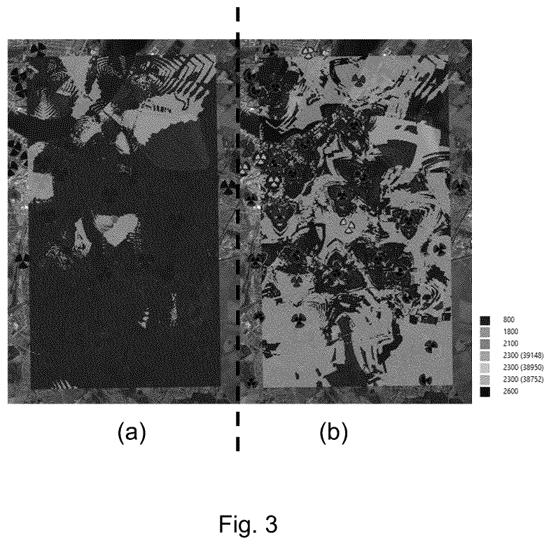

In the example shown in FIG. 3b, more than 50000 samples of crowdsourced data have been used to train the model described herein and the server carrier for each pixel in the area has been predicted. Pixels of 20 m×20 m have been considered to divide the area.

As a result, FIG. 3 is a graph illustrating the predicted server carrier in each pixel of the area using two different approaches. The left map shown in FIG. 3a shows the result when a simple methodology based on the carrier with highest RSRP is selected. The right map shown in FIG. 3b shows the result using particular embodiments described herein. As can be observed, the solutions are significantly different. With the highest RSRP methodology shown in FIG. 3a, lowest carriers are almost always predicted because they present better propagation conditions, but this approach is not considering the network configuration. On the other hand, the methodology of particular embodiments shown in FIG. 3b, that is learning from real data, is capable of understanding the network configuration and providing more complex predictions.

To measure the accuracy of these predictions, 30% of the samples available in the crowdsourced data have not been used for training and they have been later used for testing. The obtained accuracy in this dataset for the proposed methodology is 62.3%.

Likewise, the approach based on the highest RSRP, that is a methodology commonly used in network design to determine the serving carrier, obtains an accuracy of 22.7% in the same testing dataset. This value can be used as a benchmark accuracy and it demonstrates the accuracy of particular embodiments, especially considering that some of the used features (i.e., RSRP and RSRQ) are also predicted, which includes some error in the final predictions. Nonetheless, particular embodiments provide an accuracy that is almost 40 percentage points higher, and it has proven to be a reliable, helpful, and easy to use solution for network design.

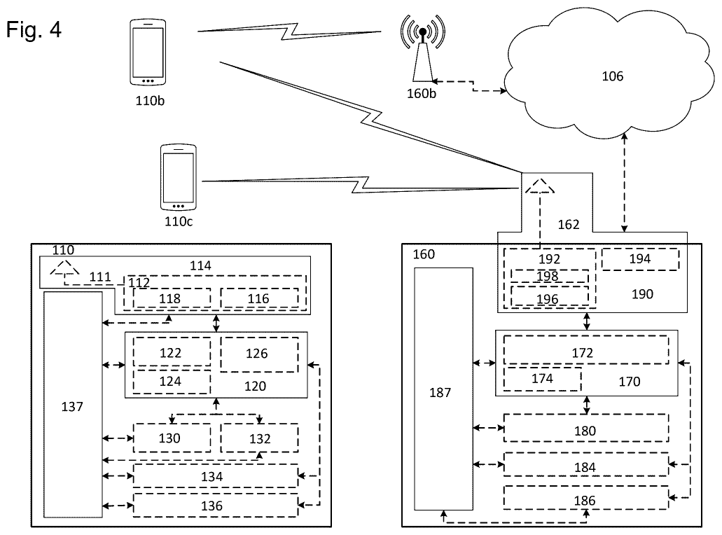

FIG. 4 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used. Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

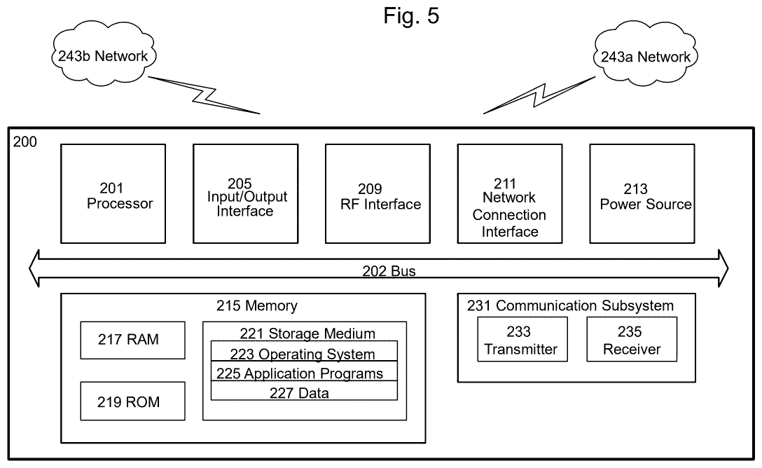

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network. FIG. 5 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3rd Generation Partnership Project (3GPP), including a NB-IoT UE, a machine type communication (MTC) UE, and/or an enhanced MTC (eMTC) UE. UE 200, as illustrated in FIG. 5, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

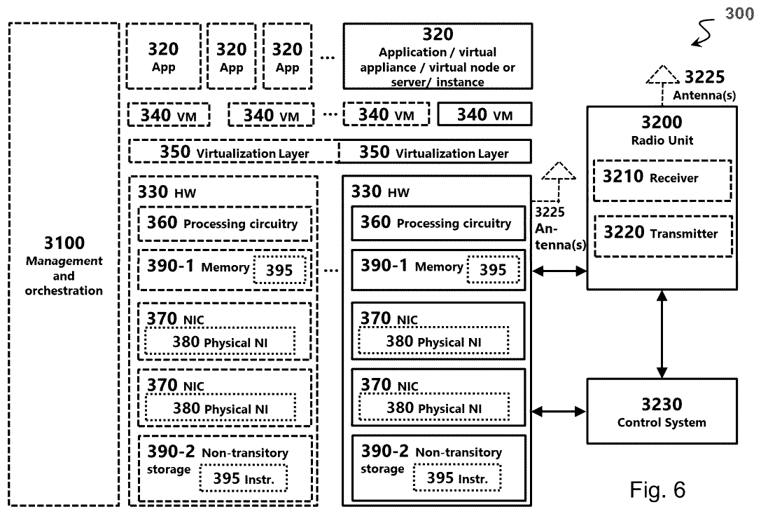

FIG. 6 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways. During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 6, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

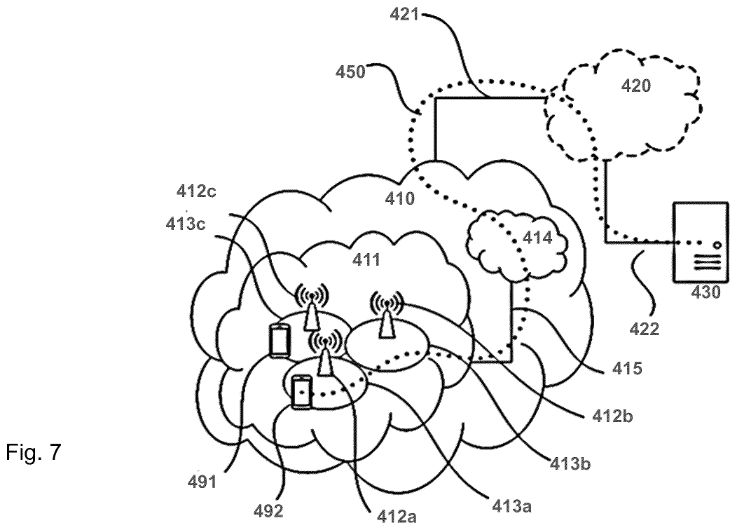

With reference to FIG. 7, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 7 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

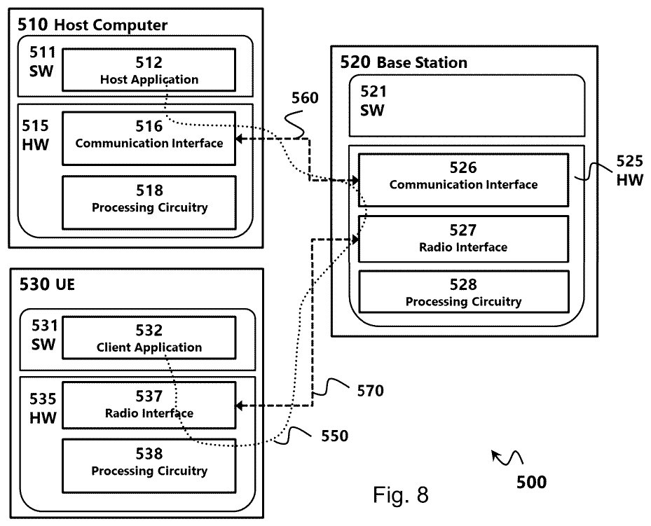

FIG. 8 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 8. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 8) served by base station 520. Communication interface 526 may be configured to facilitate connection 560 to host computer 510. Connection 560 may be direct, or it may pass through a core network (not shown in FIG. 8) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 8 may be similar or identical to host computer 430, one of base stations 412a, 412b, 412c and one of UEs 491, 492 of FIG. 5, respectively. This is to say, the inner workings of these entities may be as shown in FIG. 8 and independently, the surrounding network topology may be that of FIG. 5.

In FIG. 8, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc. ; the reconfiguring need not affect base station 520, and it may be unknown or imperceptible to base station 520. Such procedures and functionalities may be known and practiced in the art. In certain embodiments, measurements may involve proprietary UE signaling facilitating host computer 510′s measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

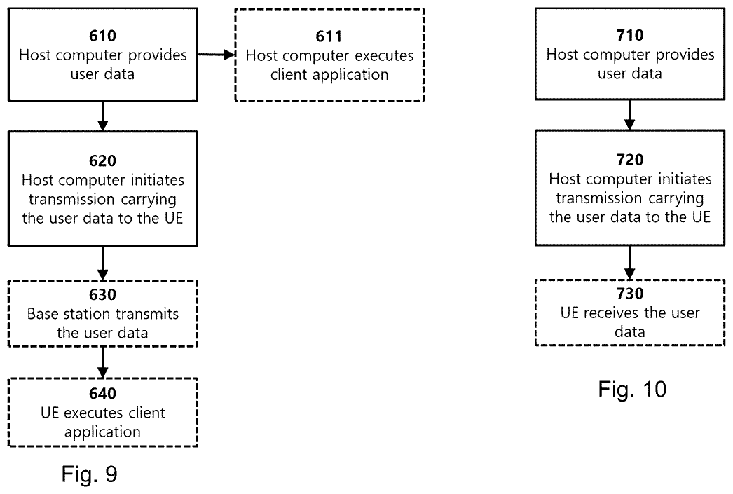

FIG. 9 FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 9 FIG. 10 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

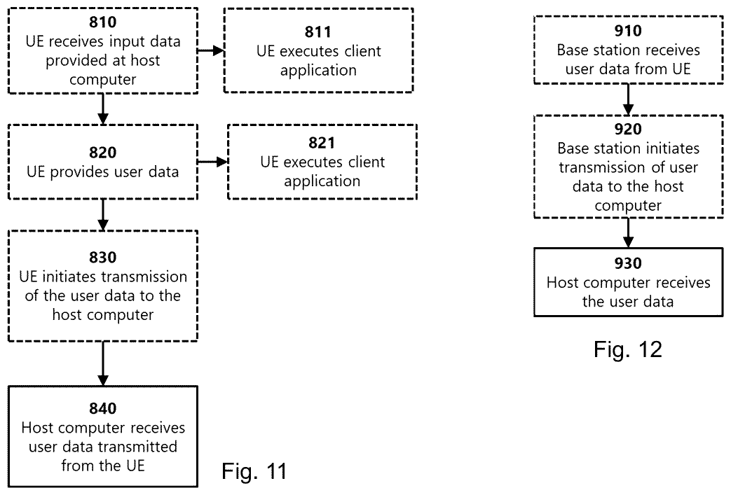

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

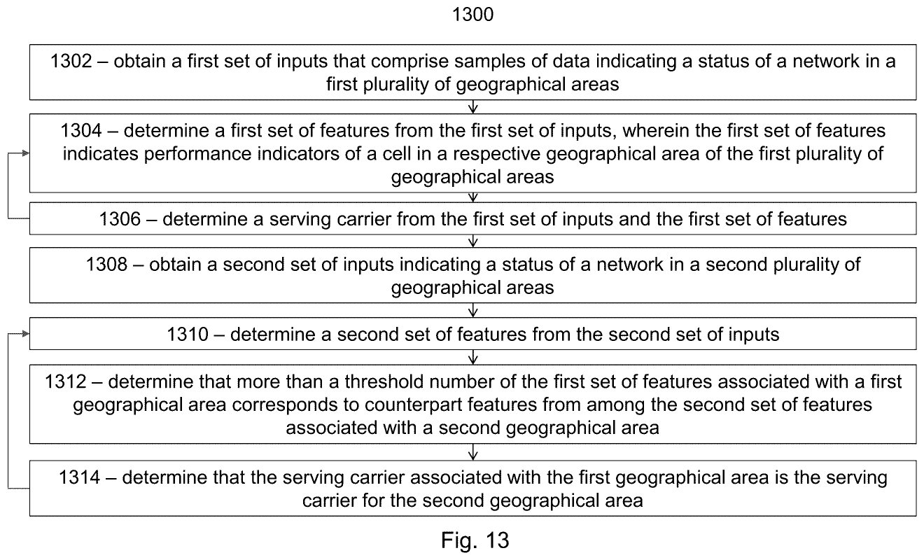

FIG. 13 is flowchart illustrating an example method in a network node, according to certain embodiments. In particular embodiments, one or more steps of FIG. 13 may be performed by network node 160 described with respect to FIG. 4. In some embodiments, the network node may comprise a core network node, a host node, a network modeling tool server, or any suitable network node. The network node is operable to predict serving carriers in a wireless network for a target geographical area. The method may be divided into a learning/training phase and a prediction phase.

The method begins at step 1302, where the network node (e.g., network node 160), in a learning/training phase, obtains a first set of inputs that comprise samples of data indicating a status of a network (e.g., RSRP/RSRQ as measured by UE) in a first plurality of geographical areas. For example, the first set of inputs may comprise any records that contain the RSRP and the RSRQ for the best server cell of each carrier and the actual serving carrier for the given record.

In some embodiments, the RSRP and RSRQ values may be the real measurements provided by the UEs. In some embodiments, the RSRP and RSRQ values may be calculated or predicted by other tools, such as prediction tools.

In particular embodiments, the first set of inputs comprises crowdsourced records. In some embodiments, the first set of inputs may be obtained from UE traces, drive tests, etc.

In particular embodiments, the first set of inputs comprises one or more of the following: serving cell RSRP measurement for a respective cell in the respective geographical area of the first plurality of geographical areas; serving cell RSRQ measurement for the respective cell in the respective geographical area of the first plurality of geographical areas; PM data for the respective cell in the respective geographical area of the first plurality of geographical areas; and CM data for the respective cell in the respective geographical area of the first plurality of geographical areas. In particular embodiments, the first set of inputs comprise any of the inputs described with respect to the embodiments and examples described herein.

For each geographical area of the first plurality of geographical areas where the samples of data are available, the method comprises the following steps.

At step 1304, the network nodes determines a first set of features from the first set of inputs. The first set of features indicate performance indicators of a cell in a respective geographical area of the first plurality of geographical areas.

In particular embodiments, the first set of features comprises at least one of the following: load of a respective cell during a period when the first set of inputs is obtained; reference signal received power (RSRP) in a respective geographical area from the respective cell; reference signal received quality (RSRQ) in the respective geographical area from the respective cell; ranking that indicates a ranking of the respective cell compared to other cells in terms of RSRP values; a1a2SearchThresholdRsrp that represents a RSRP threshold value for the respective cell that determines whether a user equipment (UE) enters or leaves an inter-frequency search zone; a1a2SearchThresholdRsrq that represents an RSRQ threshold value for the respective cell that determines whether a UE enters or leaves the inter-frequency search zone; a2CriticalThresholdRsrp that represents an RSRP threshold value for the respective cell that determines whether a UE starts or stops searching for target cells in other frequencies to leave a serving cell; a2CriticalThresholdRsrq that represents a RSRQ threshold value for the respective cell that determines whether a UE starts or stops searching for target cells in other frequencies to leave the serving cell; inhibitA2SearchConfig that indicates whether RSRP and RSRQ measurements take effect in a mobility control at a less than a threshold percentage coverage; and best RSRP carrier that indicates a carrier with a highest RSRP in the respective geographical area. In particular embodiments, the first set of features comprise any of the features described with respect to the embodiments and examples described herein.

At step 1306, the network node determines a serving carrier from the first set of inputs and the first set of features. In particular embodiments, each set of features of the first set of features is labeled with a respective serving carrier. The first set of features labeled with respective serving carriers is used to train a machine learning algorithm that is configured to predict serving carriers in geographical areas other than the first plurality of geographical areas based at least on the first set of features labeled with respective serving carriers.

Steps 1304-1306 may be repeated for each geographical area of the first plurality of geographical areas.

The method then enters a prediction phase where, at step 1308, the network node obtains a second set of inputs indicating a status of a network in a second plurality of geographical areas. In particular embodiments, the second set of inputs comprises one or more of the following: serving cell RSRP measurement for a respective cell in the respective geographical area of the second plurality of geographical areas; serving cell RSRQ measurement for the respective cell in the respective geographical area of the second plurality of geographical areas; PM data for the respective cell in the respective geographical area of the second plurality of geographical areas; and CM data for the respective cell in the respective geographical area of the second plurality of geographical areas. In particular embodiments, the second set of inputs comprise any of the inputs described with respect to the embodiments and examples described herein.

For each geographical area of the second plurality of geographical areas where samples of data are not available, the method further comprises the following steps.

At step 1310, the network node determines a second set of features from the second set of inputs. The second set of features indicate performance indicators of a cell in a respective geographical area of the second plurality of geographical areas.

In particular embodiments, the second set of features comprises one or more of the following: load that indicates an average percentage of PRBs used for a respective cell during a period when the serving carrier for the respective cell is going to be predicted; RSRP that indicates RSRP in a respective geographical area from the respective cell; RSRQ that indicates RSRQ in the respective geographical area from the respective cell; ranking that indicates a ranking of the respective geographical cell compared to other cells in terms of RSRP values; a1a2SearchThresholdRsrp that represents a RSRP threshold value for the respective cell that determines whether a user equipment (UE) enters or leaves an inter-frequency search zone; a1a2SearchThresholdRsrq that represents a RSRQ threshold value for the respective cell that determines whether a UE enters or leaves the inter-frequency search zone; a2CriticalThresholdRsrp that represents an RSRP threshold value for the respective cell that determines whether a UE starts or stops searching for target cells in other frequencies to leave a serving cell; a2CriticalThresholdRsrq that represents an RSRQ threshold value for the respective cell that determines whether a UE starts or stops searching for target cells in other frequencies to leave the serving cell; inhibitA2SearchConfig that indicates whether RSRP and/or RSRQ measurements take effect in a mobility control at a less than a threshold percentage coverage; and best RSRP carrier that indicates a carrier with a highest RSRP in the respective geographical area. In particular embodiments, the second set of features comprise any of the features described with respect to the embodiments and examples described herein.

Next, the network node compares the second set of features with the first set of features to look for similarities to predict the serving carrier for particular geographical areas. At step 1312, the network node determines that more than a threshold number of the first set of features associated with a first geographical area from among the first plurality of geographical areas corresponds to counterpart features from among the second set of features associated with a second geographical area from among the second plurality of geographical areas. The network node may compare the feature sets according to any of the embodiments and examples described herein.

In response to determining that more than the threshold number of the first set of features associated with the first geographical area corresponds to the counterpart features from among the second set of features associated with the second geographical area, a step 1314 the network node determines that the serving carrier associated with the first geographical area is the serving carrier for the second geographical area.

Steps 1310-1314 may be repeated for each geographical area of the second plurality of geographical areas.

Modifications, additions, or omissions may be made to method 1300 of FIG. 13. Additionally, one or more steps in the method of FIG. 13 may be performed in parallel or in any suitable order.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

The following are example embodiments.

### GROUP A EMBODIMENTS

Example 1. A method performed by a user equipment for predicting serving carriers in a wireless network for a target geographical area, the method comprising:
providing sample data to a network node, wherein the sample data indicates a status of a network in a respective geographical area of a first plurality of geographical areas.

Example 2. The method of any of the previous embodiments, further comprising:
providing user data; and
forwarding the user data to a host via the transmission to the network node.

Example 3. A method performed by a wireless device, the method comprising:
any of the wireless device steps, features, or functions described above, either alone or in combination with other steps, features, or functions described above.

Example 4. The method of the previous embodiments, further comprising one or more additional wireless device steps, features or functions described above.

Example 5. The method of any of the previous embodiments, further comprising:
providing user data; and
forwarding the user data to a host via the transmission to the network node.

### GROUP B EMBODIMENTS

Example 6. A method performed by a network node for predicting serving carriers in a wireless network for a target geographical area, the method comprising:
obtaining a first set of inputs that comprises samples of data indicating a status of a network in a first plurality of geographical areas;
for each geographical area of the first plurality of geographical areas where the samples of data are available:
   determining a first set of features from the first set of inputs, wherein the first set of features indicates performance indicators of a cell in a respective geographical area of the first plurality of geographical areas;
   determining a serving carrier from the first set of inputs;
obtaining a second set of inputs indicating a status of a network in a second plurality of geographical areas;
for each geographical area of the second plurality of geographical areas where samples of data are not available:
   determining a second set of features from the second set of inputs, wherein the second set of features indicates performance indicators of a cell in a respective geographical area of the second plurality of geographical areas;
   determining that the more than a threshold number of the first set of features associated with a first geographical area from among the first plurality of geographical areas corresponds to counterpart features from among the second set of features associated with a second geographical area from among the second plurality of geographical areas; and
   in response to determining that more than the threshold number of the first set of features associated with the first geographical area corresponds to the counterpart features from among the second set of features associated with the second geographical area, determining that the serving carrier associated with the first geographical area is the serving carrier for the second geographical area.

Example 7. The method of embodiment 6, wherein each of a plurality of first sets of features is labeled with a respective serving carrier, and
wherein the plurality of first sets of features labeled with respective serving carriers is used to train a machine learning algorithm that is configured to predict serving carriers in geographical areas other than the first plurality of geographical areas based at least on the plurality of first sets of features labeled with respective serving carriers.

Example 8. The method of any one of embodiments 6-7, wherein the first set of inputs comprises at least one of the following:
serving cell Reference Signal Received Power (RSRP) measurement for a respective cell in the respective geographical area of the first plurality of geographical areas;
serving cell Reference Signal Received Quality (RSRQ) measurement for the respective cell in the respective geographical area of the first plurality of geographical areas;
performance management (PM) data for the respective cell in the respective geographical area of the first plurality of geographical areas; and
configuration management (CM) data for the respective cell in the respective geographical area of the first plurality of geographical areas.

Example 9. The method of any one of embodiments 6-8, wherein the first set of features comprises at least one of the following:
Cell_{carrier_i} load that indicates an average percentage of Physical Resource Blocks (PRBs) used for a respective cell during a period when the first set of inputs is obtained;
Cell_{carrier_i} RSRP that indicates Reference Signal Received Power (RSRP) in a respective geographical area from the respective cell, wherein if more than one Cell_{carrier_i} RSRP is obtained at the respective geographical area, the Cell_{carrier_i} RSRP is a median of Cell_{carrier_i} RSRP values;
Cell_{carrier_i} RSRQ that indicates Reference Signal Received Quality (RSRQ) in the respective geographical area from the respective cell, wherein if more than one Cell_{carrier_i} RSRQ is obtained at the respective geographical area, the Cell_{carrier_i} RSRQ is a median of Cell_{carrier_i} RSRQ values;
Cell_{carrier_i} ranking that indicates a ranking of the respective cell compared to other cells in terms of RSRP values;
CellCarrier_i a1a2SearchThresholdRsrp that represents a RSRP threshold value for the respective cell that determines whether a user equipment (UE) enters or leaves an inter-frequency search zone;
CellCarrier_i a1a2Search ThresholdRsrq that represents an RSRQ threshold value for the respective cell that determines whether a UE enters or leaves the inter-frequency search zone;
CellCarrier_i a2CriticalThresholdRsrp that represents an RSRP threshold value for the respective cell that determines whether a UE starts or stops searching for target cells in other frequencies to leave a serving cell;
CellCarrier_i a2CriticalThresholdRsrq that represents a RSRQ threshold value for the respective cell that determines whether a UE starts or stops searching for target cells in other frequencies to leave the serving cell;
CellCarrier_i inhibitA2SearchConfig that indicates whether RSRP and/or RSRQ measurements take effect in a mobility control at a less than a threshold percentage coverage; and
Best RSRP carrier that indicates a carrier with a highest RSRP in the respective geographical area,
wherein the carrier_i represents a number of a respective carrier in the respective cell in the respective geographical area of the first plurality of geographical areas.

Example 10. The method of any one of embodiments 6-9, wherein the second set of inputs comprises at least one of the following:
serving cell Reference Signal Received Power (RSRP) measurement for a respective cell in the respective geographical area of the second plurality of geographical areas;
serving cell Reference Signal Received Quality (RSRQ) measurement for the respective cell in the respective geographical area of the second plurality of geographical areas;
performance management (PM) data for the respective cell in the respective geographical area of the second plurality of geographical areas; and
configuration management (CM) data for the respective cell in the respective geographical area of the second plurality of geographical areas.

Example 11. The method of any one of embodiments 6-10, wherein the second set of features comprises at least one of the following:
Cell_{carrier_i} load that indicates an average percentage of Physical Resource Blocks (PRBs) used for a respective cell during a period when the serving carrier for the respective cell is going to be predicted;
Cell_{carrier_i} RSRP that indicates Reference Signal Received Power (RSRP) in a respective geographical area from the respective cell, wherein if more than one Cell_{carrier_i} RSRP is obtained at the respective geographical area, the Cell_{carrier_i} RSRP is a median of Cell_{carrier_i} RSRP values;
Cell_{carrier_i} RSRQ that indicates Reference Signal Received Quality (RSRQ) in the respective geographical area from the respective cell, wherein if more than one Cell_{carrier_i} RSRQ is obtained at the respective geographical area, the Cell_{carrier_i} RSRQ is a median of Cell_{carrier_i} RSRQ values;
Cell_{carrier_i} ranking that indicates a ranking of the respective geographical cell compared to other cells in terms of RSRP values;
CellCarrier_i a1a2SearchThresholdRsrp that represents a RSRP threshold value for the respective cell that determines whether a user equipment (UE) enters or leaves an inter-frequency search zone;
CellCarrier_i a1a2SearchThresholdRsrq that represents a RSRQ threshold value for the respective cell that determines whether a UE enters or leaves the inter-frequency search zone;
CellCarrier_i a2CriticalThresholdRsrp that represents an RSRP threshold value for the respective cell that determines whether a UE starts or stops searching for target cells in other frequencies to leave a serving cell;
CellCarrier_i a2CriticalThresholdRsrq that represents an RSRQ threshold value for the respective cell that determines whether a UE starts or stops searching for target cells in other frequencies to leave the serving cell;
CellCarrier_i inhibitA2SearchConfig that indicates whether RSRP and/or RSRQ measurements take effect in a mobility control at a less than a threshold percentage coverage; and
Best RSRP carrier that indicates a carrier with a highest RSRP in the respective geographical area,
wherein the carrier_i represents a number of a respective carrier in the respective cell in the respective geographical area of the second plurality of geographical areas.

Example 12. The method of any of the previous embodiments, further comprising:
obtaining user data; and
forwarding the user data to a host or a user equipment.

Example 13. A method performed by a network node, the method comprising:
any of the steps, features, or functions described above with respect to network node, either alone or in combination with other steps, features, or functions described above.

Example 14. The method of the previous embodiments, further comprising one or more additional network node steps, features or functions described above.

Example 15. The method of any of the previous embodiments, further comprising:
obtaining user data; and
forwarding the user data to a host or a user equipment.

### GROUP C EMBODIMENTS

Example 16. A user equipment for predicting serving carriers in a wireless network for a target geographical area, comprising:
processing circuitry configured to perform any of the steps of any of the Group A embodiments; and
power supply circuitry configured to supply power to the processing circuitry.

Example 17. A network node for predicting serving carriers in a wireless network for a target geographical area, the network node comprising:
processing circuitry configured to perform any of the steps of any of the Group B embodiments;
power supply circuitry configured to supply power to the processing circuitry.

Example 18. A user equipment (UE) for predicting serving carriers in a wireless network for a target geographical area, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group an input interface connected to the processing circuitry and configured to allow input of information into the UE to be processed by the processing circuitry;
an output interface connected to the processing circuitry and configured to output information from the UE that has been processed by the processing circuitry; and a battery connected to the processing circuitry and configured to supply power to the UE.

Example 19. A host configured to operate in a communication system to provide an over-the-top (OTT) service, the host comprising:
processing circuitry configured to provide user data; and a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

Example 20. The host of the previous embodiment, wherein the cellular network further includes a network node configured to communicate with the UE to transmit the user data to the UE from the host.

Example 21. The host of the previous 2 embodiments, wherein:
the processing circuitry of the host is configured to execute a host application, thereby providing the user data; and
the host application is configured to interact with a client application executing on the UE, the client application being associated with the host application.

Example 22. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

Example 23. The method of the previous embodiment, further comprising:
at the host, executing a host application associated with a client application executing on the UE to receive the user data from the UE.

Example 24. The method of the previous embodiment, further comprising:
at the host, transmitting input data to the client application executing on the UE, the input data being provided by executing the host application,
wherein the user data is provided by the client application in response to the input data from the host application.

Example 25. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

Example 26. The host of the previous embodiment, wherein the cellular network further includes a network node configured to communicate with the UE to transmit the user data from the UE to the host.

Example 27. The host of the previous 2 embodiments, wherein:
the processing circuitry of the host is configured to execute a host application, thereby providing the user data; and
the host application is configured to interact with a client application executing on the UE, the client application being associated with the host application.

Example 28. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

Example 29. The method of the previous embodiment, further comprising:
at the host, executing a host application associated with a client application executing on the UE to receive the user data from the UE.

Example 30. The method of the previous embodiment, further comprising:
at the host, transmitting input data to the client application executing on the UE, the input data being provided by executing the host application,
wherein the user data is provided by the client application in response to the input data from the host application.

Example 31. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Example 32. The host of the previous embodiment, wherein:
the processing circuitry of the host is configured to execute a host application that provides the user data; and
the UE comprises processing circuitry configured to execute a client application associated with the host application to receive the transmission of user data from the host.

Example 33. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

Example 34. The method of the previous embodiment, further comprising, at the network node, transmitting the user data provided by the host for the UE.

Example 35. The method of any of the previous 2 embodiments, wherein the user data is provided at the host by executing a host application that interacts with a client application executing on the UE, the client application being associated with the host application.

Example 36. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Example 37. The communication system of the previous embodiment, further comprising:
the network node; and/or
the user equipment.

Example 38. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Example 39. The host of the previous 2 embodiments, wherein:
the processing circuitry of the host is configured to execute a host application, thereby providing the user data; and
the host application is configured to interact with a client application executing on the UE, the client application being associated with the host application.

Example 40. The host of the any of the previous 2 embodiments, wherein the initiating receipt of the user data comprises requesting the user data.

Example 41. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

Example 42. The method of the previous embodiment, further comprising at the network node, transmitting the received user data to the host.

1. A method performed by a network node for predicting serving carriers in a wireless network for a target geographical area, the method comprising:
obtaining a first set of inputs that comprise samples of data indicating a status of a network in a first plurality of geographical areas;
for each geographical area of the first plurality of geographical areas where the samples of data are available:
determining first set of features from the first set of inputs, wherein the first set of features indicates performance indicators of a cell in a respective geographical area of the first plurality of geographical areas;
determining serving carrier from the first set of inputs and the first set of features;
obtaining a second set of inputs indicating a status of a network in a second plurality of geographical areas;
for each geographical area of the second plurality of geographical areas where samples of data are not available:
determining a second set of features from the second set of inputs, wherein the second set of features indicates performance indicators of a cell in a respective geographical area of the second plurality of geographical areas;
determining that more than a threshold number of the first set of features associated with a first geographical area from among the first plurality of geographical areas corresponds to counterpart features from among the second set of features associated with a second geographical area from among the second plurality of geographical areas; and
in response to determining that more than the threshold number of the first set of features associated with the first geographical area corresponds to the counterpart features from among the second set of features associated with the second geographical area, determining that the serving carrier associated with the first geographical area is the serving carrier for the second geographical area.

2. The method of claim 1, wherein each set of features of the first set of features is labeled with a respective serving carrier, and
wherein the first set of features labeled with respective serving carriers is used to train a machine learning algorithm that is configured to predict serving carriers in geographical areas other than the first plurality of geographical areas based at least on the first set of features labeled with respective serving carriers.

3. The method of claim 1 wherein the first set of inputs comprises one or more of the following:
serving cell reference signal received power (RSRP) measurement for a respective cell in the respective geographical area of the first plurality of geographical areas; and
serving cell reference signal received quality (RSRQ) measurement for the respective cell in the respective geographical area of the first plurality of geographical areas.

4. The method of claim 1, wherein the first set of inputs comprises one or more of the following:
performance management (PM) data for the respective cell in the respective geographical area of the first plurality of geographical areas; and
configuration management (CM) data for the respective cell in the respective geographical area of the first plurality of geographical areas.

5. The method of any claim 1, wherein the first set of features comprises at least one of the following:
load of a respective cell during a period when the first set of inputs is obtained;
reference signal received power (RSRP) in a respective geographical area from the respective cell;
reference signal received quality (RSRQ) in the respective geographical area from the respective cell;
ranking that indicates a ranking of the respective cell compared to other cells in terms of RSRP values;
a1a2SearchThresholdRsrp that represents a RSRP threshold value for the respective cell that determines whether a user equipment (UE) enters or leaves an inter-frequency search zone;
a1a2SearchThresholdRsrq that represents an RSRQ threshold value for the respective cell that determines whether a UE enters or leaves the inter-frequency search zone;
a2CriticalThresholdRsrp that represents an RSRP threshold value for the respective cell that determines whether a UE starts or stops searching for target cells in other frequencies to leave a serving cell;
a2CriticalThresholdRsrq that represents a RSRQ threshold value for the respective cell that determines whether a UE starts or stops searching for target cells in other frequencies to leave the serving cell;
inhibitA2SearchConfig that indicates whether RSRP and RSRQ measurements take effect in a mobility control at a less than a threshold percentage coverage; and
best RSRP carrier that indicates a carrier with a highest RSRP in the respective geographical area.

6. The method of claim 5, wherein one or more of the RSRP and RSRQ are obtained via a prediction tool.

7. The method of claim 1, wherein the second set of inputs comprises one or more of the following:
serving cell reference signal received power (RSRP) measurement for a respective cell in the respective geographical area of the second plurality of geographical areas; and
serving cell reference signal received quality (RSRQ) measurement for the respective cell in the respective geographical area of the second plurality of geographical areas.

8. The method of claim 1, wherein the second set of inputs comprises one or more of the following:
performance management (PM) data for the respective cell in the respective geographical area of the second plurality of geographical areas; and
configuration management (CM) data for the respective cell in the respective geographical area of the second plurality of geographical areas.

9. The method of claim 1, wherein the second set of features comprises one or more of the following:
load that indicates an average percentage of physical resource blocks (PRBs) used for a respective cell during a period when the serving carrier for the respective cell is going to be predicted;
RSRP that indicates reference signal received power (RSRP) in a respective geographical area from the respective cell;
RSRQ that indicates reference signal received quality (RSRQ) in the respective geographical area from the respective cell;
ranking that indicates a ranking of the respective geographical cell compared to other cells in terms of RSRP values;
a1a2SearchThresholdRsrp that represents a RSRP threshold value for the respective cell that determines whether a user equipment (UE) enters or leaves an inter-frequency search zone;
a1a2Search ThresholdRsrq that represents a RSRQ threshold value for the respective cell that determines whether a UE enters or leaves the inter-frequency search zone;
a2CriticalThresholdRsrp that represents an RSRP threshold value for the respective cell that determines whether a UE starts or stops searching for target cells in other frequencies to leave a serving cell;
a2CriticalThresholdRsrq that represents an RSRQ threshold value for the respective cell that determines whether a UE starts or stops searching for target cells in other frequencies to leave the serving cell;
inhibitA2SearchConfig that indicates whether RSRP and/or RSRQ measurements take effect in a mobility control at a less than a threshold percentage coverage; and
best RSRP carrier that indicates a carrier with a highest RSRP in the respective geographical area.

10. The method of claim 1, wherein the first set of inputs comprises crowdsourced records.

11. A network node operable to predict serving carriers in a wireless network for a target geographical area, the wireless device comprising processing circuitry operable to:
obtain a first set of inputs that comprise samples of data indicating a status of a network in a first plurality of geographical areas;
for each geographical area of the first plurality of geographical areas where the samples of data are available:
determine a first set of features from the first set of inputs, wherein the first set of features indicates performance indicators of a cell in a respective geographical area of the first plurality of geographical areas;
determine a serving carrier from the first set of inputs and the first set of features;
obtain a second set of inputs indicating a status of a network in a second plurality of geographical areas;
for each geographical area of the second plurality of geographical areas where samples of data are not available:
determine a second set of features from the second set of inputs, wherein the second set of features indicates performance indicators of a cell in a respective geographical area of the second plurality of geographical areas;
determine that more than a threshold number of the first set of features associated with a first geographical area from among the first plurality of geographical areas corresponds to counterpart features from among the second set of features associated with a second geographical area from among the second plurality of geographical areas; and
in response to determining that more than the threshold number of the first set of features associated with the first geographical area corresponds to the counterpart features from among the second set of features associated with the second geographical area, determine that the serving carrier associated with the first geographical area is the serving carrier for the second geographical area.

12. The network node of claim 11, wherein each set of features of the first set of features is labeled with a respective serving carrier, and
wherein the first set of features labeled with respective serving carriers is used to train a machine learning algorithm that is configured to predict serving carriers in geographical areas other than the first plurality of geographical areas based at least on the first set of features labeled with respective serving carriers.

13. The network node of claim 11, wherein the first set of inputs comprises one or more of the following:
serving cell reference signal received power (RSRP) measurement for a respective cell in the respective geographical area of the first plurality of geographical areas; and
serving cell reference signal received quality (RSRQ) measurement for the respective cell in the respective geographical area of the first plurality of geographical areas.

14. The network node of claim 11, wherein the first set of inputs comprises one or more of the following:
performance management (PM) data for the respective cell in the respective geographical area of the first plurality of geographical areas; and
configuration management (CM) data for the respective cell in the respective geographical area of the first plurality of geographical areas.

15. The network node of claim 11, wherein the first set of features comprises at least one of the following:
load of a respective cell during a period when the first set of inputs is obtained;
reference signal received power (RSRP) in a respective geographical area from the respective cell;
reference signal received quality (RSRQ) in the respective geographical area from the respective cell;
ranking that indicates a ranking of the respective cell compared to other cells in terms of RSRP values;
a1a2SearchThresholdRsrp that represents a RSRP threshold value for the respective cell that determines whether a user equipment (UE) enters or leaves an inter-frequency search zone;
a1a2SearchThresholdRsrq that represents an RSRQ threshold value for the respective cell that determines whether a UE enters or leaves the inter-frequency search zone;
a2CriticalThresholdRsrp that represents an RSRP threshold value for the respective cell that determines whether a UE starts or stops searching for target cells in other frequencies to leave a serving cell;
a2CriticalThresholdRsrq that represents a RSRQ threshold value for the respective cell that determines whether a UE starts or stops searching for target cells in other frequencies to leave the serving cell;
inhibitA2SearchConfig that indicates whether RSRP and RSRQ measurements take effect in a mobility control at a less than a threshold percentage coverage; and
best RSRP carrier that indicates a carrier with a highest RSRP in the respective geographical area.

16. The network node of claim 15, wherein one or more of the RSRP and RSRQ are obtained via a prediction tool.

17. The network node of claim 11, wherein the second set of inputs comprises one or more of the following:
serving cell reference signal received power (RSRP) measurement for a respective cell in the respective geographical area of the second plurality of geographical areas; and
serving cell reference signal received quality (RSRQ) measurement for the respective cell in the respective geographical area of the second plurality of geographical areas.

18. The network node of claim 11, wherein the second set of inputs comprises one or more of the following:
performance management (PM) data for the respective cell in the respective geographical area of the second plurality of geographical areas; and
configuration management (CM) data for the respective cell in the respective geographical area of the second plurality of geographical areas.

19. The network node of claim 11, wherein the second set of features comprises one or more of the following:
load that indicates an average percentage of physical resource blocks (PRBs) used for a respective cell during a period when the serving carrier for the respective cell is going to be predicted;
RSRP that indicates reference signal received power (RSRP) in a respective geographical area from the respective cell;
RSRQ that indicates reference signal received quality (RSRQ) in the respective geographical area from the respective cell;
ranking that indicates a ranking of the respective geographical cell compared to other cells in terms of RSRP values;
a1a2SearchThresholdRsrp that represents a RSRP threshold value for the respective cell that determines whether a user equipment (UE) enters or leaves an inter-frequency search zone;
a1a2SearchThresholdRsrq that represents a RSRQ threshold value for the respective cell that determines whether a UE enters or leaves the inter-frequency search zone;
a2CriticalThresholdRsrp that represents an RSRP threshold value for the respective cell that determines whether a UE starts or stops searching for target cells in other frequencies to leave a serving cell;
a2CriticalThresholdRsrq that represents an RSRQ threshold value for the respective cell that determines whether a UE starts or stops searching for target cells in other frequencies to leave the serving cell;
inhibitA2SearchConfig that indicates whether RSRP and/or RSRQ measurements take effect in a mobility control at a less than a threshold percentage coverage; and
best RSRP carrier that indicates a carrier with a highest RSRP in the respective geographical area.

20. The network node of claim 11, wherein the first set of inputs comprises crowdsourced records.
